(19) United States
(12) Patent Application Publication
(10) Pub. No.: US 2023/0109307 A1
(43) Pub. Date: Apr. 6, 2023

(54) Lift Device for a Tugger Train Trailer and Tugger Train Trailer with a Lift Device

(71) Applicant: LR Intralogistik GmbH, Woerth an der Isar (DE)

(72) Inventors: Michael Zimmer, Ergolding (DE); Fritz Berghammer, Landshut (DE)

(21) Appl. No.: 17/801,928

(22) PCT Filed: Feb. 3, 2021
(86) PCT No.: PCT/EP2021/052476

§ 371 Date: Aug. 24, 2022

(30) Foreign Application Priority Data
Feb. 28, 2020 (DE) 10 2020 105 367.3

(51) Int. Cl. B66F 9/20; B62D 53/00

(52) U.S. Cl. CPC B66F 9/205; B62D 53/005

(57) ABSTRACT

A lift device (10) of a tugger train trailer(1) is disclosed for raising and lowering a cargo carried in the tugger train trailer (1). The lift device (10) has a lifting shaft (21) driven by a drive motor (20) and mounted so that it can rotate around an axis of rotation (D), and to which at least one lift linkage (25a; 25b; 25c; 25d) that raises and lowers the cargo is coupled in an articulated manner at some distance from the axis of rotation (D) of the lifting shaft (21).

### SUMMARY

This application is the United States national phase of International Application No. PCT/EP2021/052476 filed Feb. 3, 2021, and claims priority to German Pat. Application No. 10 2020 105 367.3 filed Feb. 28, 2020, the disclosures of which are hereby incorporated by reference in their entirety.

### BACKGROUND OF THE INVENTION

### Field of the Invention

The present invention relates to a lift device of a tugger train trailer to raise and lower a cargo being carried in the tugger train trailer.The invention further relates to a tugger train trailer with a chassis and a lift device.

### Description of Related Art

Tugger trains are being used with increasing frequency for the internal transport of loads, for example in the production departments of production plants. They consist of a tow vehicle such as a tractor, for example, and a plurality of tugger train trailers which are attached to the tractor and on which the cargo is transported.

DE 10 2014 100 865 A1 describes a tugger train trailer with a chassis that comprises a front axle module and a rear axle module. The front axle module and the rear axle module each comprise a lift mast profile in which a transport device that receives the cargo can be raised and lowered. For this purpose the transport device is provided with a first coupling section with which the transport device is guided vertically in the lift mast profile of the front axle module, and is provided with a second coupling section with which the transport device is guided vertically in the lift mast profile of the rear axle module. To raise and lower the transport device with respect to the axle modules of the chassis, a lift device is provided which has a lift unit in the vicinity of each coupling section of the transport device. The lift units are in the form of electric lead screws or electro-hydraulically driven lift cylinders, the base part of each of which is fastened to the corresponding coupling section of the transport device. Elements of the lift units that can be extended vertically downward are supported on the associated front axle module or rear axle module.

On the tugger train trailer described in DE 10 2014 100 865 A1, the lift device to raise and lower the transport device and therefore to raise and lower the cargo it is carrying is in the form of a lift unit in the form of an electric lead screw or an electro-hydraulically driven lift cylinder between the transport device and the front axle module and an additional lift unit in the form of an electric lead screw or an electro-hydraulically driven lift cylinder between the transport device and the rear axle module, so that the lift device has a plurality of electric lead screws or electro-hydraulically driven lift cylinders.

To lift the cargo carried in the tugger train trailer with a lift device which, as described in DE 10 2014 100 865 A1, has a plurality of electric lead screws, it is necessary for the electric lead screws to run in a synchronized manner to be able to lift cargo such as dollies, trolleys, pallets or mesh boxes carried in the tugger train trailer. Furthermore, all the electric lead screws must be monitored by means of appropriate sensors to monitor the lift device and to detect the lift status, because in the event of the failure of a lead screw, there is a danger of the loss of the cargo or damage to the lift device. In the top end-of-travel position of the raised transport device, the electric drive motors of the electric lead screws are not in a no-load condition because the lead screws are only self-locking to a limited extent. If an unintentional lowering of the load occurs during the transport of the raised cargo in the traveling tugger train trailer, the cargo must therefore be lifted back up, for example by means of an electronic control device that actuates the electric lead screws.

A lift device of a tugger train trailer that comprises a plurality of electric lead screws as in DE 10 2014 100 865 A1 therefore has the following disadvantages:
A plurality of electric lead screws are required to raise and lower the cargo;
the electric lead screws must be synchronized;
the electric drive motors of the electric lead screws are not in a no-load condition in the top end-of-travel position;
Each electric lead screw must be monitored individually and therefore separately by means of corresponding sensors.

### SUMMARY OF THE INVENTION

The object of the present invention is to make available a lift device of a tugger train trailer and a tugger train trailer with a lift device that eliminates one or more of the disadvantages described above.

According to the invention, this object is accomplished by a lift device of a tugger train trailer for lifting and lowering a cargo carried in the tugger train trainer, wherein the lift device has a lifting shaft that is driven by means of a drive motor and is mounted so that it can rotate around an axis of rotation, to which shaft at least one lift linkage that raises and lowers the cargo is coupled in an articulated manner at some distance from the axis of rotation of the lifting shaft.

A lift device of this type with a lifting shaft driven by a drive motor, on which one or more lift linkages to lift the cargo carried on the tugger train trailer are coupled in an articulated manner at some distance from the axis of rotation of the lifting shaft, forms a crank mechanism for raising and lowering cargo carried in the tugger train trailer. Only a single drive motor is necessary to drive the lifting shaft, which makes it possible to reduce the cost and effort required to construct the lift device. A plurality of lift linkages can be coupled to the lifting shaft, as a result of which all the lift linkages rise simultaneously and in synchronization as the lifting shaft is rotated. Therefore the synchronization of a plurality of electric drives is no longer necessary.

According to one advantageous embodiment of the invention, the lift device has at least two lift linkages which are located at some distance from each other in the longitudinal direction of the lifting shaft. Corresponding lift linkages can be coupled in an articulated manner to the lifting shaft in a simple manner, so that the lift device can be adjusted in a simple manner by a variation of the number and positioning of the lift linkages to the requirements of the tugger train trailer and the cargo to be transported.

According to one advantageous configuration of the invention, the lift linkage is coupled in an articulated manner to a crank arm device located non-rotationally on the lifting shaft. The crank arm device therefore forms a crank arm which is located non-rotationally on the lifting shaft and is coupled in an articulated manner to the corresponding lift linkage. With a plurality of crank arm devices of this type, by rotating the lifting shaft the lift linkage can be actuated in a simple manner to raise and lower the cargo carried in the tugger train trailer.

According to one advantageous embodiment of the invention, the crank arm device has two crank discs located at some distance from each other on the lifting shaft, between which the lift linkage is located. Crank discs of this type can be manufactured in a simple manner. With crank discs of this type, the crank arm device can therefore be manufactured in a simple manner. A favorable flow of force between the linkage and the crank discs can be achieved if the corresponding linkage is located between two crank discs and is coupled in an articulated manner with the crank discs.

According to one advantageous embodiment of the invention, the lift linkage is coupled in an articulated manner with a fastening pin located on the crank arm device oriented parallel to the axis of rotation of the lifting shaft, as a result of which an articulated coupling of the lift linkage with the crank arm device is achieved.

According to one advantageous development of the invention, the lift linkage is in the form of a hook profile in the vicinity of the coupling to the lifting shaft, and is designed so that the hook profile, in a top end-of-travel position of the lift linkage, is in contact with an interior surface on an outside surface of the lifting shaft to support the lift linkage on the lifting shaft. In the top end-of-travel position of the lift linkage and therefore when the cargo is raised, the lift linkage can therefore make contact with and support the corresponding hook profile on the lifting shaft, as a result of which the load is removed from the drive motor of the lift device in the top end-of-travel position and thus when the cargo is raised.

In one advantageous embodiment of the invention the drive motor, in particular an electric drive motor, is in an operative connection with the lifting shaft for its drive by means of a transmission, in particular a flexible transmission. This makes it possible in a simple manner to locate the drive motor laterally next to the lifting shaft. In addition, with the transmission, a speed reduction can be achieved, so that a small drive motor can be used. The flexible transmission can be a chain transmission or a belt transmission, for example a toothed belt transmission.

Particular advantages can be achieved if, according to one development of the invention, a dead center interlock between the lift linkage and the lifting shaft is realized in the top end-of-travel position. It thereby becomes possible in a simple manner to prevent the raised cargo from unintentionally being lowered into the moving tugger train trailer.

According to one advantageous embodiment of the invention, the lifting shaft is a spline shaft or an involute spline shaft. On a lifting shaft of this type, any desired number of crank arm devices can be located in a simple manner and positioned in any desired fashion in the longitudinal direction of the lifting shaft to adjust the lift device to the requirements of the tugger train trailer and of the cargo to be transported.

The crank arm device is advantageously provided with a complementary hub profile that interacts with the spline shaft or the involute spline shaft. With a hub profile of this type, the crank arm device can in a simple manner be located non-rotationally on the lifting shaft.

According to one advantageous development of the invention, a sensor device in an operative connection with the lifting shaft is provided. On the lift device claimed by the invention, the lift device can be monitored and the lift status recognized with a single sensor device that detects the rotational position of the lifting shaft.

According to one advantageous development of the invention, the lifting shaft is provided with a mechanical interface, with which a hand tool can be operatively connected for the manual actuation of the lifting shaft. In the event of a failure of the drive motor, it is thereby possible in a simple manner, using a hand tool, which is applied to the interface of the lifting shaft, for example, to manually actuate the lifting shaft to be able to raise and lower the cargo manually. The hand tool can be formed by a lever, for example.

The object of the invention is also accomplished by a tugger train trailer with a chassis which has two axle modules located at some distance from each other in the longitudinal direction of the vehicle, between which the cargo being carried is located, and which is provided with a lift device according to the invention.

According to one advantageous configuration of the invention, the tugger train trailer has a bridge-type frame that connects the axle modules, which frame has vertical supports located on the axle modules and a longitudinal beam that connects the vertical supports, wherein the lifting shaft of the lift device is rotationally mounted on the longitudinal beam. The lifting shaft is preferably oriented in the longitudinal direction of the longitudinal beam. The bridge-type frame connects and therefore spans the two axle modules, between which the cargo being carried is located. The lifting shaft can thereby be rotationally mounted in a simple and favorable manner on the longitudinal beam of the bridge-type frame, as a result of which the cargo can be raised and lowered in a simple manner with the lift linkages coupled to the lifting shaft.

On the tugger train trailer according to the invention, according to one embodiment it is possible to raise and lower the load carriers located between the two axle modules directly with the lift linkages, for example by providing the lift linkages with corresponding hooks on the end which can be suspended on the load carriers.

According to one advantageous embodiment of the invention, the tugger train trailer has a transport device to receive the cargo, wherein the transport device is located between the axle modules and can be raised and lowered with respect to the axle modules by means of the lift device, wherein the lift linkage of the lift device is operatively connected with the transport device. The cargo is therefore received by the transport device, which can be raised and lowered by means of the lift device.

In this case the transport device is advantageously located on each of the axle modules, by means of a respective vertical guide so that it can be raised and lowered. With corresponding vertical guides, it is possible in a simple manner to achieve a vertical guidance of the transport device on the two axle modules, so that the lift linkage is required to transmit only the lift forces to raise the transport device.

In one advantageous configuration of the invention, the transport device has a platform to drive on dollies having rollers as load carriers, wherein the dollies are supported with rollers on the platform. On a transport device of this type having a platform, therefore in a simple manner one or more dollies can be driven on with their rollers and transported in the tugger train trailer. With the lift device according to the invention, the platform with the dollies standing on it can be raised and lowered in a simple manner.

According to an alternative and advantageous configuration of the invention, the transport device has a plurality of forks to position the cargo. With positioning forks, pallets or mesh boxes as load carriers can be received in a simple manner. With the lift device according to the invention, a plurality of forks can be raised and lowered simultaneously.

The lift device according to the invention and a tugger train trailer with a lift device according to the invention have a series of advantages.

The lift device according to the invention has a simple and economical construction and makes it possible to raise and lower a plurality of load carriers with a single drive motor. If a plurality of lift linkages are actuated by the lifting shaft, the travel of the lift linkage is mechanically coupled by means of the lifting shaft. If a plurality of load carriers are lifted with the lift device, all the load carriers ascend simultaneously with the lift device according to the invention. With the hook profile on the lift linkages, which in the top end-of-travel position of the lift linkage is in contact with an interior surface on the exterior surface of the lifting shaft and supports the lift linkage on the lifting shaft, the drive motor is in a no-load status in the top end-of-travel position. The height of the lift that can be achieved by the lift device can be adjusted in a simple manner by changing the angle of rotation of the lifting shaft. Larger changes in lift height can be achieved simply by replacing the crank arm devices and therefore the crank discs with other crank arms. In the event of a failure of the drive motor of the lift device, the lifting shaft can be actuated manually by means of a hand tool connected with the interface of the lifting shaft, to effect the lifting of the load module manually. On the lift device according to the invention, the lifting shaft needs to be detected with only one single sensor device to be able to detect the lift status of the lift device. The lift device according to the invention can be flexibly adjusted to the number of load carriers, the loads to be lifted, the lift height and the lifting speed, because the number of lift linkages and the position of the lift linkages in the longitudinal direction of the lifting shaft can be arbitrarily selected and different crank arm devices with different crank arms can be fastened to the lifting shaft.

Additional advantages and details of the invention are explained in greater detail below with reference to the exemplary embodiment illustrated in the accompanying schematic drawings, in which:

### BRIEF DESCRIPTION OF THE DRAWINGS

FIG. 1 is a view in perspective of a tugger train trailer according to the invention with a lift device according to the invention,

FIG. 2 is a side view of the tugger train trailer from FIG. 1 in a lowered position of a transport device,

FIG. 3 shows the tugger train trailer from FIG. 2 with the transport device in the raised position,

FIG. 4 is a detail of the lift device according to the invention.

FIGS. 5a to 5d show the lift device according to the invention in multiple lift positions.

### DESCRIPTION OF THE INVENTION

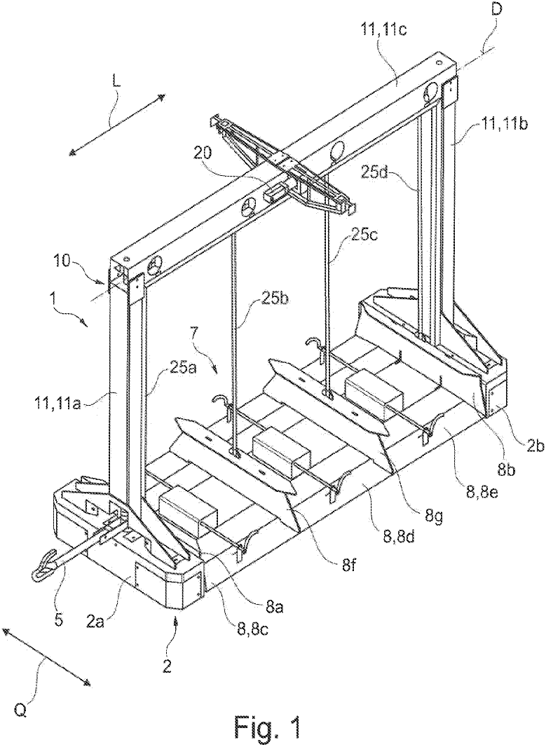

FIGS. 1 to 3 show a tugger train trailer 1 according to the invention of a tugger train.

The tugger train trailer 1 has a chassis 2 which has two axle modules 2a, 2b located at some distance from each other in the longitudinal direction L of the vehicle. The axle module 2a is in the form of a front axle module and is provided with front wheels 3. The axle module 2b is in the form of a rear axle module and is provided with rear wheels 4. Located on the axle module 2a is a steerable tiller 5 with which the tugger train trailer 1 can be attached to a tractor vehicle or to a preceding tugger train trailer of the tugger train. The axle module 2b is equipped with a trailer coupling 6, to which an additional tugger train trailer of the tugger train can be attached. The front wheels 3 and/or the rear wheels 4 can be steered. If both the front wheels 3 and the rear wheels 4 are steered, the steering movement of the front wheels and the steering movement of the rear wheels can be coupled.

A cargo can be carried between the axle module 2a and the axle module 2b. To receive the cargo, the tugger train trailer 1 has a transport device 7 which is located between the two axle modules 2a, 2b.

The transport device 7 can be raised and lowered with respect to the axle modules 2a, 2b by means of a lift device 10. For the vertical guidance of the transport device 7, a vertical guide, not shown in any further detail, is provided between the transport device 7 and the axle module 2a and between the transport device 7 and the axle module 2a respectively.

In the illustrated exemplary embodiment, the transport device 7 has a platform 8 for driving on dollies, which are not illustrated in any detail, as load carriers for the cargo, and which are supported with rollers on the platform 8. The platform 8 extends in the transverse direction Q of the vehicle over the entire width of the vehicle, so that the dollies can be pushed up onto and down off the platform 8 from both sides of the vehicle. In the illustrated exemplary embodiment, the platform 8, in the vicinity of the axle module 2a, has a vertical transverse plate 8a that runs in the transverse direction Q of the vehicle, and is guided in the vertical direction by means of a vertical guide on the axle module 2a. In the illustrated exemplary embodiment, the platform 8, in the vicinity of the axle module 2b, has a vertical transverse plate 8b that runs in the transverse direction Q of the vehicle, and is guided in the vertical direction by means of a vertical guide on the axle module 2b.

In the illustrated exemplary embodiment —- viewed in the longitudinal direction L of the vehicle — the platform 8 has three positioning channels 8c, 8d, 8e, onto each of which a dolly can be driven. Between the front positioning channel 8c and the middle positioning channel 8d, there is a vertical partition web 8f that runs in the transverse direction Q of the vehicle. Accordingly, between the middle positioning channel 8d and the rear positioning channel 8e, there is a vertical partition web 8g that runs in the transverse direction Q of the vehicle.

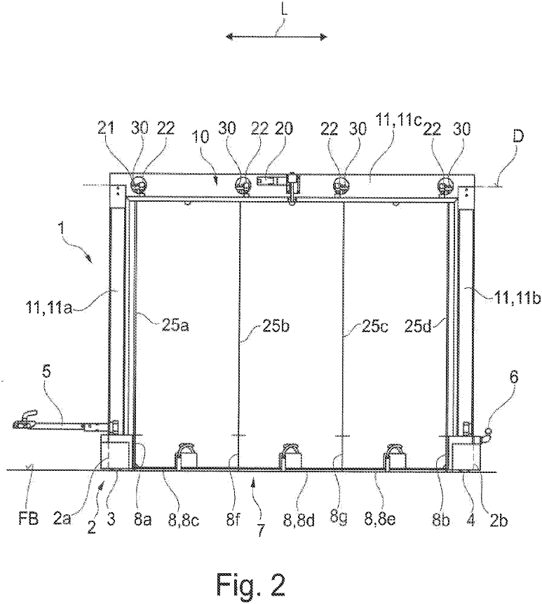

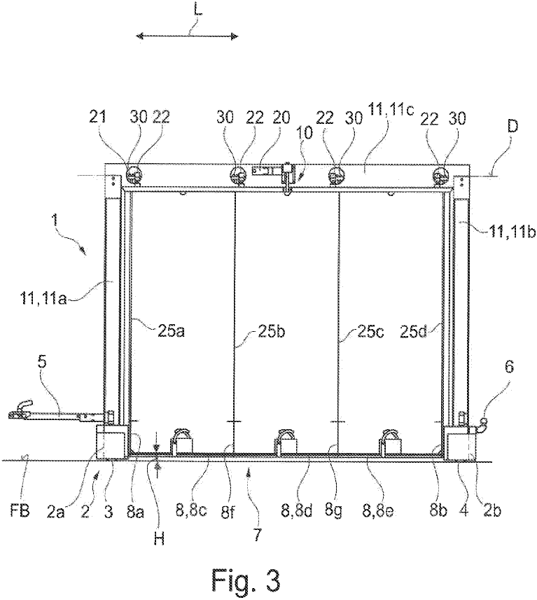

In FIG. 2, the transport device 7 is shown in the lowered position and thus in the bottom end-of-travel position, in which the platform 8 is lowered to the roadway FB so that the dollies with the rollers can be pushed onto the positioning channels 8c, 8d and 8e of the platform 8. FIG. 3 shows the transport device 7 in the raised position and thus in the top end-of-travel position, in which the platform 8 is lifted from the roadway surface FB by means of the lift device 10 by the stroke distance H.

The tugger train trailer 1 further has a U-shaped bridge-type frame 11 –- seen in a side view —that connects the axle modules 2a, 2b. The bridge-type frame 11 consists of a vertical support 11 a located on the axle module 2a, a vertical support 11 b located on the axle module 2b and a longitudinal beam 11c connecting the vertical supports 11a, 11b. The bridge-type frame 11 –-viewed in the transverse direction Q of the vehicle — is centrally located.

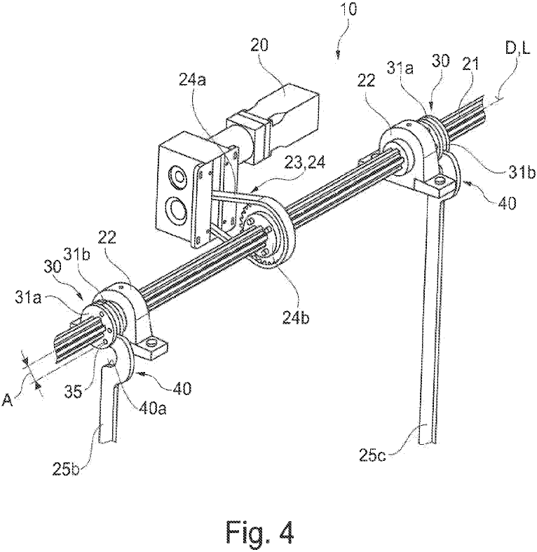

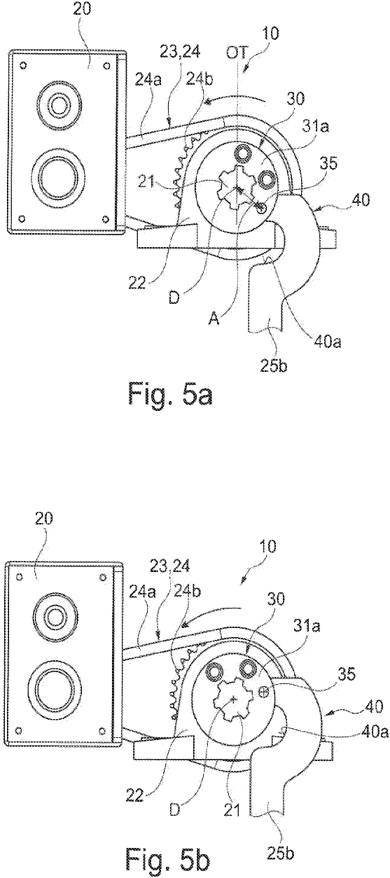

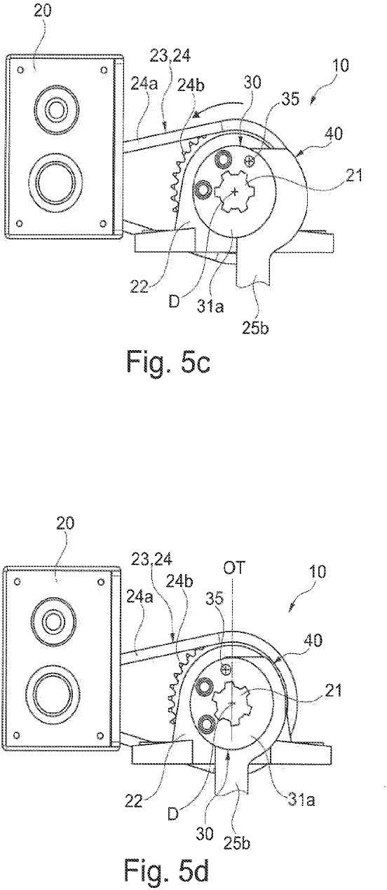

The construction of the lift device 10, by means of which the transport device 7 formed by the platform 8 can be raised and lowered relative to the axle modules 2a, 2b, is described below with reference to FIGS. 4 to 5d.

The lift device 10 has a lifting shaft 21 which is mounted rotationally around an axis of rotation D and driven by means of a drive motor 20, such as an electric motor for example. The lifting shaft 21 is oriented with the axis of rotation D in the longitudinal direction L of the vehicle. In the illustrated exemplary embodiment, the lifting shaft 21 is rotationally mounted on the longitudinal beam 11c of the bridge-type frame 11. Appropriate bearing devices 22 are provided on the longitudinal beam 11b for the mounting of the lifting shaft. For this purpose the lifting shaft 21 is installed in the longitudinal beam 11c which is in the form of a tubular profile. The drive motor 20 is also attached to the longitudinal beam 11c.

The drive motor 20 is also operatively connected by means of a transmission 23 with the lifting shaft 21 to drive it. In the illustrated exemplary embodiment, the transmission 23 comprises a flexible drive 24, which can be in the form of a chain drive, for example. The flexible drive 24 in the form of a chain drive comprises a chain 24a driven by the drive motor 20, which drives a sprocket wheel 24b which is fastened non-rotationally to the lifting shaft 21.

A plurality of lift linkages 25a-25d are coupled to the lifting shaft 21 at some distance from the axis of rotation D of the lifting shaft 21, and are therefore connected in an articulated manner with the lifting shaft 21, and are in an operative connection with the transport device 7 in the form of a platform 8 for raising and lowering the cargo. For this purpose the lift linkages 25a-25d — as shown in FIG. 4 in which the lift device 10 is shown in the bottom end-of-travel position — are coupled in an articulated manner with a lever arm or crank arm A to the lifting shaft 21.

The lift linkages 25a-25d are guided downward by corresponding recesses of the longitudinal beam 11c and are each connected by means of their respective lower ends with the transport device 7. The lift linkages 25a-25d are preferably fastened to the transport device 7 in an articulated manner.

The lift linkages 25a-25d are located at some distance from one another in the longitudinal direction of the lifting shaft 21 and thus in the longitudinal direction L of the vehicle. In the illustrated exemplary embodiment, the lift linkage 25a is connected with the platform 8 in the vicinity of the front transverse plate 8a, the lift linkage 25b is connected with the platform 8 in the vicinity of the partition web 8f, the lift linkage 25c is connected with the platform 8 in the vicinity of the partition web 8g and the lift linkage 25d is connected with the platform 8 in the vicinity of the rear transverse plate 8b.

For the articulated fastening of the lift linkages 25a-25d to the lifting shaft 21, each lift linkage 25a-25d is coupled in an articulated manner to a crank arm device 30 located non-rotationally on the lifting shaft 21. In the illustrated exemplary embodiment — as visible in FIG. 4 — the crank arm device 30 has two crank discs 31a, 31b, each located on the lifting shaft 1 at some distance from each other and connected to each other, and between which the corresponding lift linkage 25a-25d is located. In the illustrated exemplary embodiment, the articulated connection between the respective lift linkage 25a-25d and the crank discs 31a, 31b is formed by a fastening pin 35, which is located parallel to the lever arm or crank arm A at an offset to the axis of rotation D of the lifting shaft 1 in corresponding receptacle borings of the crank discs 31a, 31b. The fastening pin 35 is further held in a receptacle boring on the upper end of the corresponding lift linkage 25a, 25d.

As shown in FIG. 4, each of the lift linkages 25a-25d is realized in the vicinity of the articulated coupling to the crank arm device 30 and thus in the upper terminal area in the form of a hook profile 40. The hook profile 40 is realized so that the hook-shaped profile 40, in the upper end-of-travel position of the lift linkage 25a-25d, is in contact with an interior surface 40a against the exterior surface of the lifting shaft 21, so that in the top end-of-travel position, the vertical forces of the lift linkage 25a-25d on the lifting shaft 21 are supported.

In the illustrated example, the lifting shaft 21 is in the form of a spline shaft. The lifting shaft 21 is provided over its entire length with a corresponding spline shaft profile.

For the non-rotational connection with the lifting shaft 21, the crank arm device 30 is provided with a hub profile that interacts in a complementary manner with the spline shaft profile of the lifting shaft 21 which is in the form of a spline shaft.

The lifting shaft 21 is further provided with a mechanical interface, which is not illustrated in any further detail, to which a hand tool can be connected for the manual actuation of the lifting shaft 21. The interface is preferably formed from the forward end and/or the rear end of the lifting shaft 21 which is in the form of a spline shaft, and is accessible via the open tubular end of the longitudinal beam 11c, so that in the event of the failure of the drive motor 20, a hand tool such as a lever, for example, can be applied to the shaft end of the lifting shaft 21 which is in the form of a spline shaft, to be able to turn the lifting shaft 21 manually.

The crank arm devices 30 that sit on the lifting shaft 21 and are non-rotationally connected with the lifting shaft 21, which crank arm devices are connected with the lift linkages 25a-25d, thus form a crank mechanism for the raising and lowering of the transport device 7.

The lift device 10 comprising the lifting shaft 21, the crank arm devices 30 and the lift linkages 25a-25d can be adapted in a simple manner to different tugger train trailers 1 and to different transport devices 7 and expanded as a result of the mobility of the crank arm devices 30 on the lifting shaft 21 and an arbitrary number of crank arm devices 30, and thus of lift linkages 25a-25d on the lifting shaft 21.

The process of lifting the transport device 7 of the tugger train trailer 1 by means of the lift device 10 is described below with reference to FIGS. 5a to 5d.

In FIG. 5a, the lift device 10 is in the bottom end-of-travel position as shown in FIG. 2.

If the lifting shaft 21 is rotated by means of the drive motor 20 in the counterclockwise direction, the lift linkages 25a-25d coupled with the crank arm A to the lifting shaft 21 are actuated upward, as illustrated in FIGS. 5b and 5c. As a result of the mechanical coupling of the lift linkages 25a-25d to the lifting shaft 21, all the lift linkages 25a-25d rise simultaneously and in a synchronized manner.

In FIG. 5d, the lift device 10 is in the top end-of-travel position as shown in FIG. 3. The articulated connection formed by the fastening pin 35 of the lift linkage 25a-25d thereby overshoots the dead center point (OT) which lies in the vertical plane. Furthermore, when the dead center point OT is overshot, the hook profiles 40 of the lift linkage 25a-25d are in contact against the interior surfaces 40a on the exterior surface of the lifting shaft 21, so that the forces acting vertically downward on the lift linkages 25a-25b are supported on the lifting shaft 21. Consequently, the drive motor 20 is free of any load in the top end-of-travel position.

Furthermore, as a result of the overshooting of the dead center point OT, in the top end-of-travel position a dead center interlock is achieved between the lift linkages 25a-25d and the lifting shaft 21, so that an unintentional lowering of the raised transport device 7 is prevented.

1. A lift device of a tugger train trailer for raising and lowering a cargo carried in the tugger train trailer, wherein the lift device comprises a lifting shaft driven by a drive motor and mounted so as to rotate around an axis of rotation, and to which at least one lift linkage which raises and lowers the cargo is coupled in an articulated manner at a distance from the axis of rotation of the lifting shaft.

2. The lift device according to claim 1, wherein the lift device has at least two lift linkages which are located at a distance from one another in the longitudinal direction of the lifting shaft.

3. The lift device according to claim 1, wherein the lift linkage coupled in an articulated manner to a crank arm device located non-rotationally on the lifting shaft.

4. The lift device according to claim 3, wherein the crank arm device has two crank discs located at an axial distance from each other on the lifting shaft, and between which the lift linkage is located.

5. The lift device according claim 3, wherein the lift linkage is coupled in an articulated manner to a fastening pin oriented parallel to the axis of rotation on the crank arm device.

6. The lift device according to claim 1, wherein the lift linkage has a hook-shaped profile in the vicinity of the coupling to the lifting shaft, and is arranged so that the hook-shaped profile is in contact in a top end-of-travel position of the lift linkage with an interior surface on an exterior-surface of the lifting shaft to support the lift linkage on the lifting shaft.

7. The lift device according to claim 1, wherein the drive motor is in an operative connection by a transmission with the lifting shaft.

8. The lift device according to claim 1, wherein in a top end-of-travel position, a dead center interlock is provided between the lift linkage and the lifting shaft.

9. The lift device according to claim 1 wherein the lifting shaft is in the form of a spline shaft or an involute spline shaft.

10. The lift device according to claim 9, wherein the crank arm device is provided with a hub profile that interacts in a complementary manner with the spline shaft or involute spline shaft.

11. The lift device according to claim 1, wherein a sensor device is operatively connected with the lifting shaft.

12. The lift device according to claim 1, wherein the lifting shaft is provided with a mechanical interface to which a hand tool can be applied for the manual actuation of the lifting shaft.

13. A tugger train trailer with a chassis, which has two axle modules located at a distance from each other in longitudinal direction of the vehicle, and between which axle modules cargo being carried is located, wherein the tugger train trailer is provided with a lift device according to claim 1.

14. The tugger train trailer according to claim 13, wherein the tugger train trailer has a bridge frame connecting the axle modules, and which has vertical supports located on the axle module and a longitudinal beam connecting the vertical supports, wherein the lifting shaft of the lift device is rotationally mounted on the longitudinal beam.

15. The tugger train trailer according to claim 13, wherein the tugger train trailer has a transport device to receive the cargo, wherein the transport device is located between the axle modules and can be raised and lowered with respect to the axle modules by the lift device, and wherein the lift linkage of the lift device is operatively connected with the transport device.

16. The tugger train trailer according to claim 15, wherein the transport device is located on the axle modules by respective vertical guides so that device can be raised and lowered.

17. The tugger train trailer according to claim 15, wherein the transport device has a platform to drive on dollies that have rollers, wherein the dollies are supported on the platform with rollers.

18. The tugger train trailer according to claim 15, wherein the transport device has positioning forks to receive the cargo.
